(19) United States
(12) Patent Application Publication
(10) Pub. No.: US 2024/0000101 A1
(43) Pub. Date: Jan. 4, 2024

(54) Chewing Gum with a Liquid Filling

(71) Applicant: asCom Confection GmbH, Walldorf (DE)

(72) Inventors: Marco Magni, Walldorf (DE); Riccardo Gianoglio Bernardi, Bruchsal (DE); Uemit Yuece, Wiesloch (DE)

(73) Assignee: asCom Confection GmbH, Walldorf (DE)

(21) Appl. No.: 18/251,097

(22) PCT Filed: Sep. 23, 2021
(86) PCT No.: PCT/DE2021/200127

§ 371 Date: Apr. 28, 2023

(30) Foreign Application Priority Data
Oct. 30, 2020 (DE) 102020213676.9

(51) Int. Cl. A23G 4/20; A23G 4/06; A23G 4/02; C12G 3/06

(52) U.S. Cl. CPC A23G 4/205; A23G 4/068; A23G 4/20; A23G 4/02; C12G 3/06

(57) ABSTRACT

A chewing gum with a liquid filling, comprising a chewing gum mass that has one or more cavities, and a liquid filling contained in the cavities, characterized in that the liquid filling contains alcohol. The invention also relates to a method for producing a chewing gum of this type and to a liquid filling for the chewing gum.

The invention relates to a chewing gum having a liquid filling, as well as to a method for producing such a chewing gum, and a liquid filling for the chewing gum.

Liquid-filled confections have been known from practice for years. Fillings made, for example, of fruit juices, sugars, syrups, colorings, and/or flavors are used in gumdrops, chocolate pralines, and chewing gum. These sweeteners usually appeal to all end consumers, and are not specifically directed to certain target groups. Chewing gums having a central, sweet liquid-filled core are sold, for example, primarily to adolescents.

A chewing gum consists in principle of an edible and a non-edible part. In this case, the edible part mostly consists of polyols, sweeteners, flavorings, colorings, acids, pH regulators, and further constituents. The non-edible part is largely the chewing gum mass, which consists, for example, of fats, resins, polymers, etc.

A liquid-filled chewing gum usually has a central cavity which contains the liquid filling. In this case, the filling contains a viscous mixture of liquid polyols. Typically, maltitol, syrups, and glycerol are used. Often, sugar, corn syrup, colorings, thickeners, and/or flavors are also added to this mixture.

In order to appeal to new target groups, which can be achieved, for example, by selecting new distribution channels other than traditional supermarkets, chewing gum manufacturers are looking at chewing gums having unusual properties.

Alcohol-containing chocolate pralines can be mentioned as an example of a confection tailored to a particular target group. The target groups for alcohol-filled chocolate pralines are usually adults up to old age. These confections have a liquid, alcohol-containing filling. Often, these pralines are filled with flavors or concentrates of known spirits, in order to improve the marketing.

A problem with the use of an alcohol-containing liquid filling in a chewing gum is that both the water fraction and the alcohol fraction of the filling have a certain affinity to the edible and non-edible parts of the chewing gum.

The object of the present invention is therefore that of providing a chewing gum having a liquid alcohol-containing filling which remains storage-stable over several months and is acceptable to the consumer in terms of sensory and taste aspects.

This object is achieved by the present invention. Accordingly, the invention provides a chewing gum having a liquid filling, comprising a chewing gum mass having one or more cavities, and a liquid filling which is located in the cavities, characterized in that the liquid filling contains alcohol.

The invention also provides a method for producing the chewing gum, which is characterized in that the liquid filling is filled directly into the cavities, or in that the liquid filling is filled into edible capsules which are mixed with the chewing gum mass.

Methods for producing liquid-filled chewing gums are known from the prior art. For the direct filling of the chewing gum with the liquid filling, the chewing gums can be produced, for example, by means of extrusion. In this case, the liquid filling is co-extruded into the extruded chewing gum strand.

Furthermore, the invention provides a liquid filling for a chewing gum, which is characterized in that the filling contains alcohol—preferably in the form of an alcoholic beverage, and preferably in the form of a spirit.

An alcoholic beverage is an alcohol-containing solution that can be obtained by distillation, fermentation, dilution, and/or mixing with ethanol.

An advantage when using alcoholic beverages is that, in addition to the alcohol, other constituents, such as flavors and/or sweeteners, such as sugar, can also be introduced into the liquid filling.

In this case, the alcoholic beverage can be selected from, for example, wine, sparkling wine, beer, vermouth, spirits, or mixed beverages, such as cocktails or long drinks. Preferably, the alcoholic beverage is a spirit.

In this case, the term, spirit, comprises both the distillate obtained directly from the distillation process, which usually has an alcohol content between 70 vol % and 95 vol %, and dilutions of these distillates having an alcohol content between 30 vol % and 50 vol %, and preferably between 35 vol % and 45 vol %.

The undiluted distillate contains the highest alcohol content and the highest concentration of flavors of the respective spirits. By using the distillate in the liquid filling, it is thus advantageously possible to achieve both the highest alcohol content in the liquid filling and the best flavoring of the filling.

Accordingly, in an advantageous embodiment, the alcoholic beverage has an alcohol content of more than 30 vol %. Preferably, the alcoholic beverage has an alcohol content of more than 40 vol %, and preferably more than 50 vol %.

The alcohol content of the alcoholic beverage is advantageously between 30 vol % and 95 vol %, preferably between 40 vol % and 90 vol %, and preferably between 45 vol % and 80 vol %.

In an advantageous embodiment, the alcoholic beverage is a distillate having an alcohol content in the range of 70 vol % to 95 vol %.

The spirit can be selected, for example, from gin, rum, whiskey, brandy, cognac, grappa, vodka, fruit brandies, grain spirits, aquavit, pastis, and liqueur—in particular, herb liqueur.

Water tends to migrate into the chewing gum mass. This is a continuous process, and the volumes of water are low. Over a longer period of time, this migration of the water can be disadvantageous for the storage life of the chewing gum. In order to avoid this disadvantage, the water content in the liquid filling can be kept as low as possible.

The basic constituents of the liquid filling comprise, for example, liquid polyols, such as maltitol syrup and/or glycerol. Moreover, further syrups, such as glucose syrup, can be used. The syrups contain low fractions of water. Further water is present in the liquid filling due to the use of the alcoholic beverage. However, the liquid filling has a high content of dissolved particles, which leads to low water activity, such that the water does not migrate into the chewing gum mass.

Typically, alcoholic beverages contain more than 50 vol % water. In order to reduce the water content and at the same time also the alcohol content of the alcoholic beverage, the distillate can be diluted after the distillation in a solution of polyols such as maltitol and/or glycerol. For example, the solution is a syrup, such as maltitol syrup.

In one embodiment, the alcoholic beverage is consequently diluted in a solution of polyols. The alcoholic beverage is, advantageously, diluted in the further constituents of the liquid filling.

The use, for example, of maltitol and/or glycerol in liquid fillings for confections is known. Furthermore, sorbitol, glucose syrup, or saturated sugar solutions, such as sucrose, fructose, or dextrose solutions, are usually used. These constituents allow the liquid filling to flow after the cavities in the chewing gum mass have been bitten open. Further constituents can be added to the filling—for example, further sweeteners, colorings, thickeners, and/or flavors. Further possible sweeteners include, for example, sugar or sugar substitutes, such as acesulfame K, aspartame, or sucralose. These constituents can make up, in total, up to 99 wt % of the liquid filling. These constituents are preferably used in the filling at 50 wt % to 95 wt %.

In an advantageous embodiment, the alcoholic beverage is contained in the liquid filling at up to 10 wt %, preferably at up to 7 wt %, and preferably at up to 5 wt %. The alcoholic beverage is, advantageously, contained in the liquid filling at a fraction in the range of 0.5 wt % to 10 wt %, preferably in a range of 1 wt % to 7 wt %, and preferably in a range of 2 wt % to 5 wt %.

At a low alcohol content of the liquid filling, it may be the case that the consumer only faintly perceives the typical thermal effect of the alcohol. Therefore, further constituents may be contained in the liquid filling, which constituents enhance the thermal effect. For example, capsicum extract, pepper powder, pepper extract, and/or ginger extract are possible as such constituents.

In an advantageous embodiment, the liquid filling contains capsicum extract. Capsicum extract is derived from plants of the genus Capsicum. Representatives of this plant genus are, for example, bell pepper, chili, hot pepper, hot chili pepper, or chili pepper. The extract can be obtained by grinding the fruit or by extraction from these fruits. The capsaicinoids contained in the capsicum extract—especially capsaicin—cause a heat or pain stimulus in the oral cavity that is perceived as spiciness.

In order to avoid the liquid filling being too spicy for consumption, or the spiciness negatively affecting the taste of the chewing gum, the constituent that enhances the thermal effect must not be added in excess. It has been found that a content of up to 0.015 wt % of the thermal effect-enhancing constituent in the liquid filling does not negatively affect the consumption of the chewing gum. At below 0.002 wt % relative to the liquid filling, however, the enhancement of the thermal effect is barely noticeable.

Accordingly, in a further embodiment, the thermal-enhancing constituent can be present in the liquid filling in a range of 0.002 wt % to 0.015 wt %. Preferably, the thermal-enhancing constituent is present in the liquid filling in a range of 0.003 wt % to 0.01 wt %, and preferably about 0.005 wt %.

According to the present invention, a cavity is defined as a hollow interior space having a certain volume, which is enclosed by the chewing gum mass. This volume can be completely or partially filled with the liquid filling. Cavities containing an encapsulated liquid filling can either contain several smaller capsules or be designed such that the capsule shell of a capsule rests against the cavity surface.

In an advantageous embodiment, the chewing gum mass has a central cavity. The production of a chewing gum having a central cavity is, technically, easy to achieve. Furthermore, a central cavity, which is filled accordingly with a liquid filling, provides a surprising chewing experience for the consumer. Due to the cavity being bitten open and the subsequent outflow of the liquid filling into the oral cavity, as large as possible a region of the sensory cells in the oral cavity comes into contact with the filling.

A central cavity furthermore has the advantage that the surface of the chewing gum mass that comes into contact with the liquid filling remains as small as possible. Thus, the migration of individual constituents from the liquid filling into the chewing gum mass is reduced. The chewing gum is longer-lasting as a result.

In a further advantageous embodiment, several cavities are distributed in the chewing gum mass. These cavities can be distributed uniformly or non-uniformly in the chewing gum mass. These cavities are accordingly dimensioned to be smaller than a central cavity.

Several cavities that are distributed and filled with a liquid filling enable the chewing gum to retain its taste longer, since not all the cavities are bitten open simultaneously. In contrast to a chewing gum having a central cavity, a chewing gum having several cavities is not necessarily bound to one form. Thus, the chewing gum having several cavities can also be present, for example, in the form of a chewing gum stick.

In a further embodiment, the liquid filling is present in an edible capsule. Encapsulating the liquid filling prevents constituents of the liquid filling from migrating into the adjacent chewing gum mass and negatively influencing it. Accordingly, encapsulation of the liquid filling results in an increase in the shelf life of the chewing gum. In addition, the chewing gum is prevented from rapidly losing its taste.

Suitable capsule shells for sweeteners are well known and can be selected from, for example, gelatin, alginates, carrageen, cellulose and cellulose derivatives, and gum arabic.

In a further embodiment, the chewing gum can be provided with a coating.

By virtue of the invention, the chewing gum is storage-stable over several months—at least 6 months. Thus, the chewing gum is storage-stable for over 6 months, preferably over 12 months, and preferably over 24 months.

There are, then, various possibilities for designing and developing the teaching of the present invention in an advantageous manner. For this purpose, reference is made on the one hand to the claims dependent upon claim 1, and, on the other, to the following exemplary embodiments of the invention.

### EXAMPLE 1

The present example shows two compositions, by way of example, for a chewing gum mass.

| | A) | B) |
|---|---|---|
| Chewing gum base mass | 30 wt % | 35 wt % |
| Maltitol syrup | 15 wt % | 10 wt % |
| Xylitol | 5 wt % | 35 wt % |
| Mannitol | 5 wt % | 5 wt % |
| Sorbitol | 10 wt % | 10 wt % |
| Maltitol | 30 wt % | — |
| Liquid flavor | 2 wt % | 2 wt % |
| Flavor (powder) | 2 wt % | 2 wt % |
| Colorings | 1 wt % | 1 wt % |

### EXAMPLE 2

The present example shows two compositions, by way of example, for a liquid filling of the chewing gum.

### Composition A):

| | | |
|---|---|---|
| Alcoholic beverage: | 8 | wt % |
| Capsicum extract: | 0.01 | wt % |
| Flavor | 1 | wt % |
| Coloring | 1 | wt % |
| Thickener (optional) | 1 | wt % |
| Glycerol | 40 | wt % |
| Maltitol syrup | 48.99 | wt % |

### Composition B):

| | | |
|---|---|---|
| Alcoholic beverage: | 3 | wt % |
| Capsicum extract: | 0.005 | wt % |
| Flavor | 1 | wt % |
| Coloring | 1 | wt % |
| Thickener (optional) | 1 | wt % |
| Maltitol syrup | 48 | wt % |
| Glycerol | 45.995 | wt % |

With regard to further advantageous embodiments of the article according to the invention, in order to avoid repetition, reference is made to the general part of the description and to the appended claims.

Finally, it is expressly pointed out that the embodiments of the chewing gum according to the invention described above are merely used to explain the claimed teaching, but do not limit the teaching to the embodiments.

1: A chewing gum having a liquid filling, comprising a chewing gum mass having one or more cavities, and a liquid filling which is located in the cavities, characterized in that the liquid filling contains alcohol.

2: The chewing gum of claim 1, wherein the alcohol contained in the liquid filling comprises an alcoholic beverage—preferably a spirit.

3: The chewing gum of claim 2, characterized in that the alcoholic beverage has an alcohol content of more than 30 vol %.

4: The chewing gum of claim 2, characterized in that the alcoholic beverage is contained in the liquid filling at up to 10 wt %.

5: The chewing gum of claim 1, characterized in that the liquid filling further comprises a constituent that enhances the thermal effect of the alcohol; preferably, the constituent is selected from capsicum extract, pepper powder, pepper extract, and ginger extract.

6: The chewing gum of claim 5, characterized in that the constituent which enhances the thermal effect of the alcohol is present in a range of 0.002 wt % to 0.015 wt %.

7: The chewing gum of claim 1, characterized in that the liquid filling is present in an edible capsule.

8: A method for producing a chewing gum, wherein the chewing gum comprises:
a chewing gum mass comprising one or more cavities, and
a liquid filling which is located in the one or more cavities, wherein the liquid filling contains alcohol; and
wherein the liquid filling is filled directly into the one or more cavities, or the liquid filling is filled into edible capsules which are mixed with the chewing gum mass.

9: The method of claim 18, characterized in that the alcoholic beverage is diluted in a solution of polyols.

10: A liquid filling for a chewing gum, characterized in that the filling contains alcohol—preferably in the form of an alcoholic beverage, and preferably in the form of a spirit.

11: The chewing gum of claim 3, characterized in that the alcoholic beverage is contained in the liquid filling at up to 10 wt %.

12: The chewing gum of claim 1, wherein the liquid filling further comprises a constituent that enhances the thermal effect of the alcohol.

13: The chewing gum of claim 12, wherein the constituent comprises capsicum extract, pepper powder, pepper extract, ginger extract, or a combination of two or more of the foregoing.

14: The chewing gum of claim 2, wherein the liquid filling further comprises a constituent that enhances the thermal effect of the alcohol; preferably, the constituent is selected from capsicum extract, pepper powder, pepper extract, and ginger extract.

15: The chewing gum of claim 2, wherein the liquid filling is present in an edible capsule.

16: The chewing gum of claim 5, wherein the liquid filling is present in an edible capsule.

17: The chewing gum of claim 12, wherein the liquid filling is present in an edible capsule.

18: The chewing gum of claim 2, wherein the alcoholic beverage is diluted in a solution of polyols.

19: The method of claim 8, wherein the alcohol comprises an alcoholic beverage.

20: The liquid filling of claim 10, wherein the alcoholic beverage is diluted in a solution of polyols.
